(19) United States
(12) Patent Application Publication
(10) Pub. No.: US 2012/0064306 A1
(43) Pub. Date: Mar. 15, 2012

(54) METHOD FOR CUTTING TEMPERED GLASS, PREPARATORY STRUCTURE USED IN CUTTING TEMPERED GLASS, AND GLASS BLOCK CUT FROM TEMPERED GLASS SUBSTRATE

(76) Inventors: Hen-Ta KANG, Taichung City (TW); Jeng-Jye Hung, Tai Chung County (TW); Yung-Lin Chen, Changhua County (TW)

(21) Appl. No.: 13/228,610

(22) Filed: Sep. 9, 2011

(30) Foreign Application Priority Data
Sep. 15, 2010 (TW) 099131133
Sep. 24, 2010 (TW) 099132332

(51) Int. Cl. C03B 33/02; C03C 25/00; B32B 17/00; C03C 21/00

(52) U.S. Cl. 428/192; 65/30.14; 428/210

(57) ABSTRACT

A method for cutting a tempered glass includes the following steps. First, a shielding layer is formed on a part of a surface of a glass substrate, and a predetermined cutting path passes through the part of the surface. Then, a glass substrate is given an ion-exchange strengthening treatment, and the part of the surface covered by the shielding layer substantially does not undergo ion-exchange. Finally, the glass substrate is cut along the predetermined cutting path.

### BACKGROUND OF THE INVENTION

a. Field of the Invention

The invention relates to a method for cutting a tempered glass, a preparatory glass structure used in cutting a tempered glass, and a glass block cut from a tempered glass substrate.

b. Description of the Related Art

Generally, conventional methods for strengthening glass mainly include a heat strengthening treatment and a chemically strengthening treatment. For example, in a typical chemically strengthening treatment such as an ion-exchange strengthening treatment, a glass substrate is submersed in a bath containing a potassium salt. This causes sodium ions on the glass surface to be replaced by potassium ions from the bath solution. Under the circumstance, a thin compression stress layer is formed on the skin of the glass substrate. As shown in FIG. 1A and FIG. 1B, a tensile stress TS is formed correspondingly inside a tempered glass 100 to compensate the compression stress CS of a compression stress layer DOL. Compared FIG. 1A with FIG. 1B, when the compression stress layer DOL becomes thicker (layer thickness in FIG. 1B is larger than that in FIG. 1A), the strength of the tempered glass 100 becomes greater and the tensile stress TS inside the tempered glass 100 also becomes greater. Hence, as the tensile stress TS is increased to a considerable extent, the tempered glass 100 being cut is liable to irregularly split due to the tensile stress TS. This may result in extremely low production yields.

When the ion-exchange tempered glass is used to fabricate an electronic product, a typical fabrication process that allows to solve the aforesaid problem of low production yields is described below. First, a mother glass substrate is cut to form multiple glass blocks each having a size and a shape corresponding to a finished product. Then, each glass block is given a chemically strengthening treatment and other necessary fabrication processes. In other words, each of the glass blocks cut from a mother glass substrate needs to be chemically strengthened one after one to thus complicate fabrication processes and increase fabrication time and costs.

Accordingly, in case a mother glass substrate is given a chemically strengthening treatment and undergoes necessary fabrication processes in advance before being cut, multiple glass blocks each having a stack of films and serving as a final product are directly formed immediately after cutting the mother glass substrate. Such fabrication process is typically referred to as a “mother glass fabrication process” that allows to simplify fabrication processes and reduce processing time. However, the mother glass fabrication process is hard to carry out currently, because a mother glass substrate given an ion-exchange strengthening treatment is liable to split during cutting to result in extremely low production yields.

### BRIEF SUMMARY OF THE INVENTION

The invention provides a method having improved yield rate for cutting a tempered glass. The invention also provides a preparatory glass structure used in cutting a tempered glass and provides a glass block cut from a tempered glass substrate.

According to an embodiment of the invention, a method for cutting a tempered glass includes the steps of: forming a shielding layer on a part of a surface of a glass substrate, where a predetermined cutting path passes through the part of the surface; giving an ion-exchange strengthening treatment to the glass substrate, where the part of the surface covered by the shielding layer substantially does not undergo ion-exchange; and cutting the glass substrate along the predetermined cutting path.

In one embodiment, the shielding layer includes an inorganic material and the inorganic material may be aluminum oxide, silicide, nitride, metal oxide, or metal.

In one embodiment, the method for cutting a tempered glass further includes the step of performing a mother glass fabrication process on the glass substrate given the ion-exchange strengthening treatment before cutting the glass substrate.

In one embodiment, the step of forming a shielding layer includes coating an inorganic film on at least an entire surface of the glass substrate; defining a predetermined cutting path on the inorganic film; and removing the part of the inorganic film outside the predetermined cutting path.

In one embodiment, the tempered glass is a substrate or a cover lens of a touch panel, and the mother glass fabrication process includes forming metal traces by a first photolithography process; forming an insulation layer by a second photolithography process; forming transparent X-axis traces and transparent Y-axis traces by a third photolithography process; and forming a decorative layer by a screen printing process.

In one embodiment, the tempered glass is a transparent substrate of a display panel.

In one embodiment, the method for cutting a tempered glass includes the steps of giving edge enhancement or appearance modification to a periphery of the glass substrate. For example, the periphery of the glass substrate is etched by an etching media.

According to another embodiment of the invention, a preparatory structure used in cutting a tempered glass includes a glass substrate and at least one shielding layer. The glass substrate is given an ion-exchange strengthening treatment, and the shielding layer is formed on a part of a surface of the glass substrate and substantially overlapping a predetermined cutting path. The part of the surface covered by the shielding layer substantially does not undergo ion-exchange.

According to another embodiment of the invention, a glass block cut from a tempered glass substrate includes a top surface and a bottom surface opposite to each other, a cut surface connected between the top surface and the bottom surface, and an ion-exchange layer formed on the top surface and the bottom surface but substantially not formed on the cut surface.

In one embodiment, the glass block further includes a shielding layer formed on the top surface and the bottom surface at a position near the cut surface or overlapping a predetermined cutting path of the tempered glass substrate.

In one embodiment, the glass block further includes a decorative layer formed on at least one of the top surface and the bottom surface, and the material of the decorative layer includes at least one of diamond-like carbon, ceramic, colored ink, resin and photo resist.

According to the above embodiments, since the shielding layer blocks the formation of ion-exchange on a skin layer covered by the shielding layer, the compression stress induced by the ion-exchange does not exist in the skin layer of the glass substrate to thus reduce corresponding internal tensile stress under the shielding layer. Therefore, when one cuts the tempered glass, a tempered glass block with a demanded size and a smooth facet is obtained to improve production yields. Further, since the remainder part of the surface of the glass substrate is not covered by the shielding layer, the effect of strengthening the glass substrate is still maintained. Besides, the yield rate of cutting a tempered mother glass substrate given an ion-exchange strengthening treatment is considerably improved. Therefore, the mother glass fabrication process is allowed to use in producing a product with a tempered glass substrate to effectively simplify fabrication processes and reduce fabrication time and costs.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B show schematic diagrams of a conventionally temper glass given a chemically strengthening treatment.

FIG. 2 shows a schematic diagram illustrating a conventional problem in cutting a tempered glass.

FIG. 3 and FIG. 4 show schematic diagrams illustrating a method for cutting a tempered glass according to an embodiment of the invention.

FIG. 5 shows a schematic diagram illustrating a mother glass fabrication process.

FIG. 6 shows a schematic diagram illustrating the comparison between a glass block cut from a mother glass substrate according to an embodiment of the invention and a glass block according to a conventional design.

FIG. 7 shows a schematic diagram illustrating the comparison between a glass block cut from a mother glass substrate according to another embodiment of the invention and a glass block according to a conventional design.

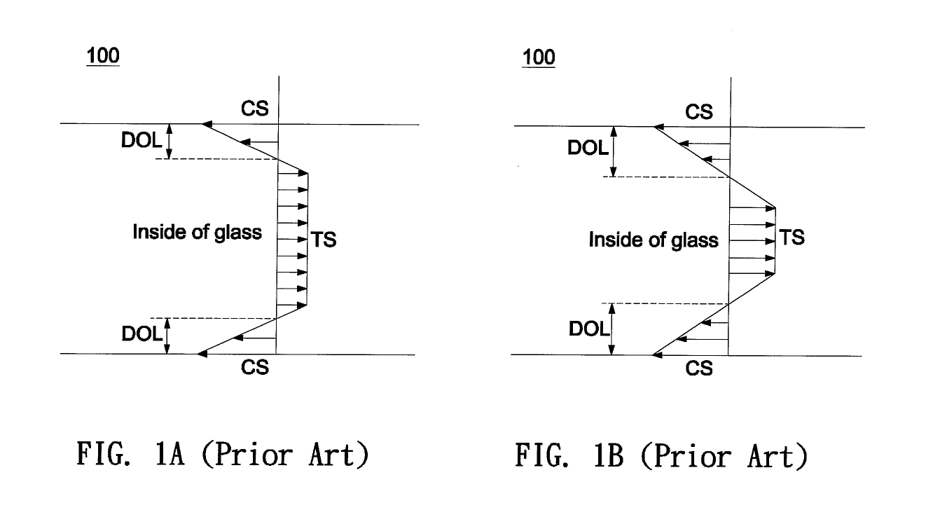

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

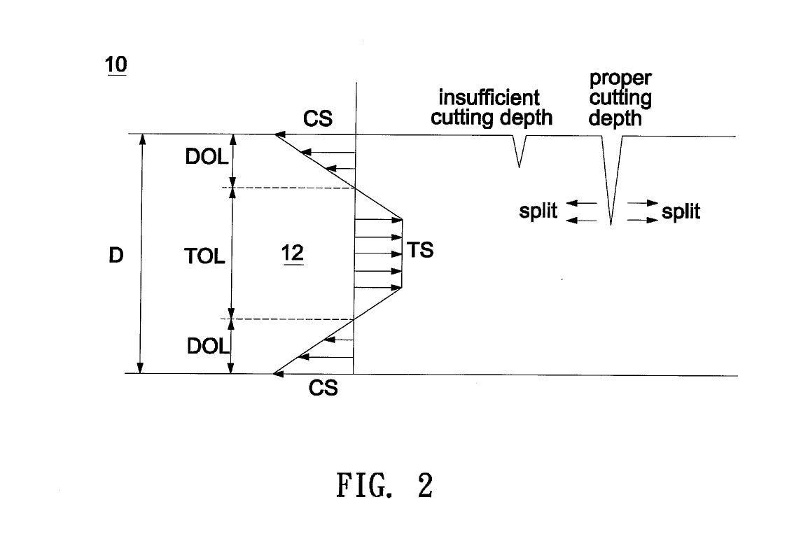

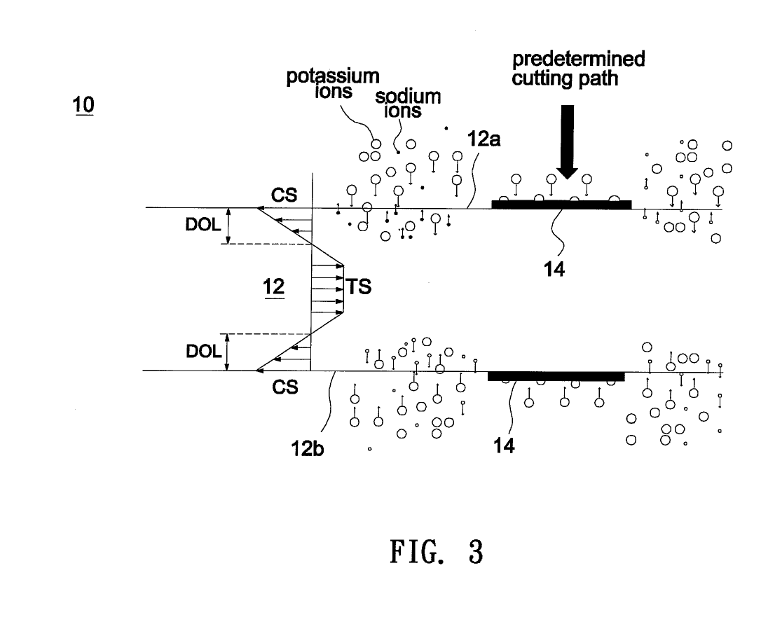

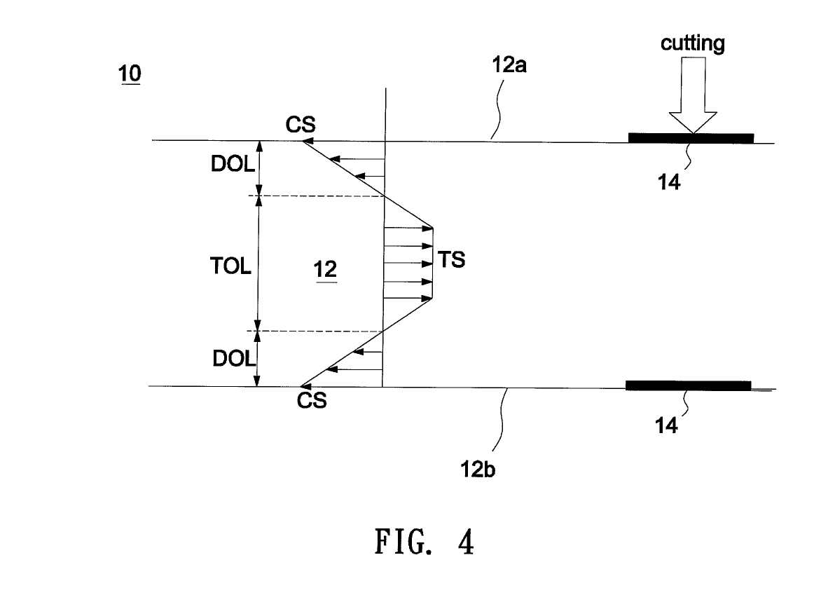

Referring to FIG. 2, a tempered glass 10 according to an embodiment of the invention is formed by a glass substrate 12 given a strengthening treatment. The glass strengthening treatment may be, for example, an ion-exchange strengthening treatment. In a typical ion-exchange strengthening treatment, the glass substrate 12 is submersed in a bath containing a potassium salt. This causes sodium ions on the skin of the glass substrate 12 to be replaced by potassium ions from the bath solution. Under the circumstance, a compression stress layer DOL is formed on the skin of the glass substrate 12, and a tensile stress TS is formed inside the glass substrate 12 to compensate the compression stress CS of the compression stress layer DOL. In other words, a compression stress layer DOL and a tensile stress layer TOL are correspondingly formed in succession from the skin to the inside of the glass substrate 12. When the compression stress layer DOL becomes thicker, the strength of the tempered glass 10 and the internal tensile stress TS become greater. When the tempered glass 10 is cut, a proper cutting depth must exceed the thickness of the compression stress layer DOL; in other words, a crack as a result of cutting may pierce the tensile stress layer TOL inside the glass substrate 12. As the tensile stress TS is increased to a considerable extent, the tip of a fracture irregularly splits due to the tensile stress TS, as shown in FIG. 2, and thus a demanded size of each glass block cut from the tempered glass 10 fails to be obtained. However, such problem is solved as long as the tensile stress TS inside the glass substrate 12 is reduced. According to an embodiment shown in FIG. 3 and FIG. 4, a shielding layer 14 (such as made from an inorganic material) is formed on a part of a surface of the glass substrate 12 through which a predetermined cutting path passes. Since the shielding layer 14 blocks the formation of ion-exchange (such as the interchange between sodium ions and potassium ions) on a skin layer covered by the shielding layer 14, the compression stress CS induced by the ion-exchange does not exist in the skin layer of the glass substrate 12 to thus reduce corresponding internal tensile stress TS under the shielding layer 14. Therefore, when one cuts the tempered glass 10, a tempered glass block with a demanded size and a smooth facet is obtained to improve production yields. Further, since the remainder part of the surface of the glass substrate 12 is not covered by the shielding layer 14, the effect of strengthening the glass substrate 12 is still maintained.

The inorganic material for forming the shielding layer 14 includes, but is not limited to, aluminum oxide, silicide, nitride, metal oxide and metal, as long as the shielding layer 14 formed by such material may block the formation of ion-exchange on the skin of the glass substrate 12. Besides, the interchange between sodium ions and potassium ions is merely illustrated as an example but not serves to limit the invention. The interchange between other ions is suitable for all embodiments of the invention, as long as the ion-exchange behavior may realize glass strengthening.

Besides, the glass strengthening treatment may be given on any region of the glass substrate 12. For example, as shown in FIG. 4, since a top surface 12a and a bottom surface 12b are both given a strengthening treatment, the shielding layer 14 are formed on a part of the top surface 12a and a part of the bottom surface 12b both. Certainly, the area and thickness of the shielding layer 14 are not limited, but the position of the shielding layer 14 needs to overlap a predetermined cutting path. Besides, the material of the glass substrate 12 includes, but is not limited to, sodium calcium silicate glass and aluminosilicate glass. Further, the strengthening treatment is not limited to the ion-exchange strengthening treatment exemplified above, and any strengthening treatment capable of forming compression stress and tensile stress in the glass substrate 12 and easing tensile stress by the shielding layer 14 is suitable for all embodiments of the invention.

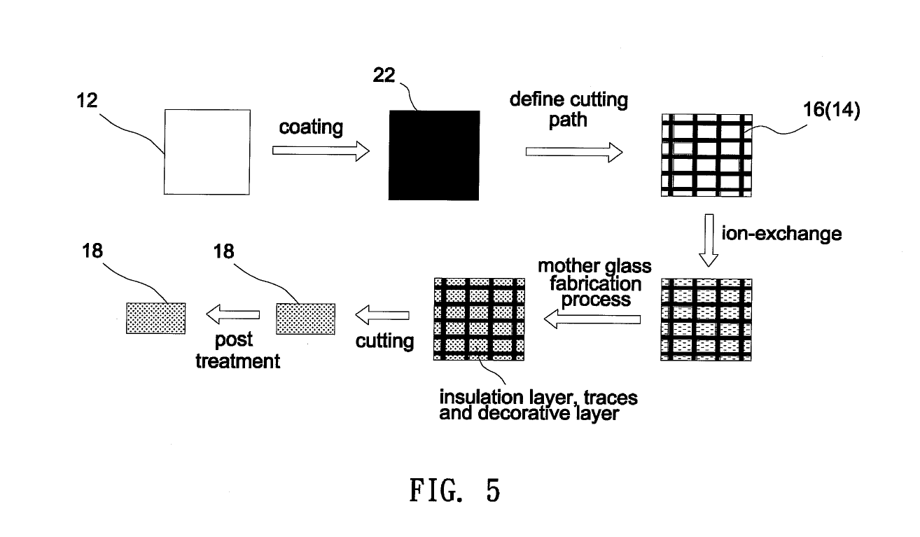

FIG. 5 shows a schematic diagram illustrating a mother glass fabrication process. According to an embodiment of the invention, a shielding layer 14 is formed on a glass substrate 12 at a position overlapping a predetermined cutting path 16, and thus ion-exchange does not occur in the cutting path 16 covered by the shielding layer 14. Referring to FIG. 5, for example, at least one side of the glass substrate 12 is first coated with an inorganic film 22 on the entire surface, and then the cutting path 16 on the glass substrate 12 is defined, and a part of the inorganic film 22 outside the cutting path 16 is removed. Therefore, a shielding layer 14 is formed and allowed to cover only the part of the glass substrate 12 overlapping the cutting path 16. The method for forming the inorganic film 22 includes, but is not limited to, atomic layer deposition and sputtering. Further, the method for forming the shielding layer 14 is not limited. For example, a mask is used to shield a region of the glass substrate 12 outside the cutting path 16, and an inorganic material is directly deposited on the cutting path 16. Next, the glass substrate 12 having the shielding layer 14 is given an ion-exchange strengthening treatment, and a mother glass fabrication process is performed on the tempered glass substrate 12. Herein, the mother glass fabrication process means the necessary processes for producing a finished product and performed on a mother glass substrate. For example, in case the tempered glass substrate 12 serves as a substrate or a cover lens of a touch panel, the mother glass fabrication process may include a first photolithography process for forming metal traces, a second photolithography process for forming an insulation layer, a third photolithography process for forming transparent X-axis traces and transparent Y-axis traces, and a screen printing process for forming a decorative layer. Alternatively, in case the tempered glass substrate 12 serves as a transparent substrate of a display panel, the mother glass fabrication process may include depositing metal and dielectric materials and performing photolithography and etching processes on a tempered mother glass substrate. The decorative layer may be formed on at least one of a top surface and a bottom surface of the glass substrate 12, and the material of the decorative layer includes at least one of diamond-like carbon, ceramic, colored ink, resin and photo resist. Also, the decorative layer may be formed on a touch panel, a display panel, or a cover lens or a glass substrate of other electronic product. After the mother glass fabrication process has been carried out, the tempered mother glass substrate is cut to directly form multiple tempered glass blocks 18 each having a stack of films. The tempered glass block 18 may be given a post treatment like edge enhancement or appearance modification, and the post treatment may include, but not limited to, edging, chamfering, peripheral etching, pigment painting and film coating. For example, after machining processes are performed, tiny cracks may be formed on the periphery of a machined glass substrate to considerably reduce the strength of the glass substrate. Therefore, in one embodiment, the peripheral cracks formed on a tempered glass block 18 as a result of cutting, edging and chamfering operations are removed by etching to increase the strength of the tempered glass block 18.

According to the above embodiments, the yield rate of cutting a tempered mother glass substrate given an ion-exchange strengthening treatment is considerably improved. Therefore, the mother glass fabrication process is allowed to use in producing a product with a tempered glass substrate to effectively simplify fabrication processes and reduce fabrication time and costs.

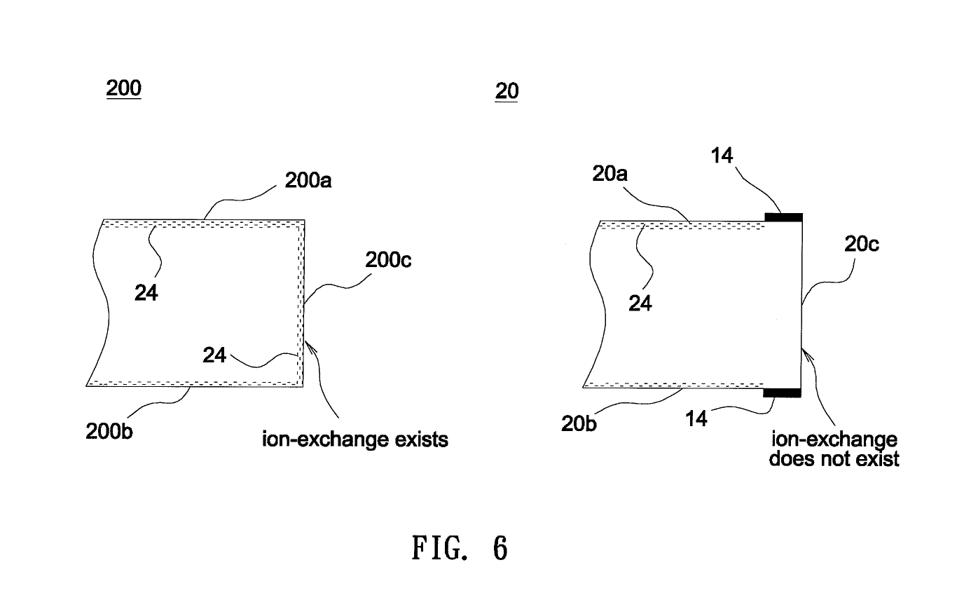

FIG. 6 shows a schematic diagram illustrating the comparison between a glass block cut from a tempered mother glass substrate according to an embodiment of the invention and a glass block according to a conventional design. As shown in the left side of FIG. 6, each conventional glass block 200 is cut from a non-tempered mother glass substrate and then given an ion-exchange strengthening treatment. Therefore, an ion-exchange layer 24 is formed on a top surface 200a, a bottom surface 200b, and a cut surface 200c connected between the top surface 200a and the bottom surface 200b. In comparison, according to this embodiment, a mother glass substrate is given an ion-exchange strengthening treatment first, and then each glass block 20 is cut from the tempered mother glass substrate. Therefore, as shown in the right side of FIG. 6, the shielding layer 14 formed on the top surface 20a and the bottom surface 20b of the glass block 20 may prevent the formation of ion-exchange on a skin layer overlapping a predetermined cutting path. Therefore, the ion-exchange layer 24 does not exist on the cut surface 20c of the tempered glass block 20. That is, interchanged ions are substantially not found on the cut surface 20c of the tempered glass block 20, and the ion-exchange layer 24 are formed only on the top surface 20a and the bottom surface 20b of the glass block 20 to provide strengthening effects.

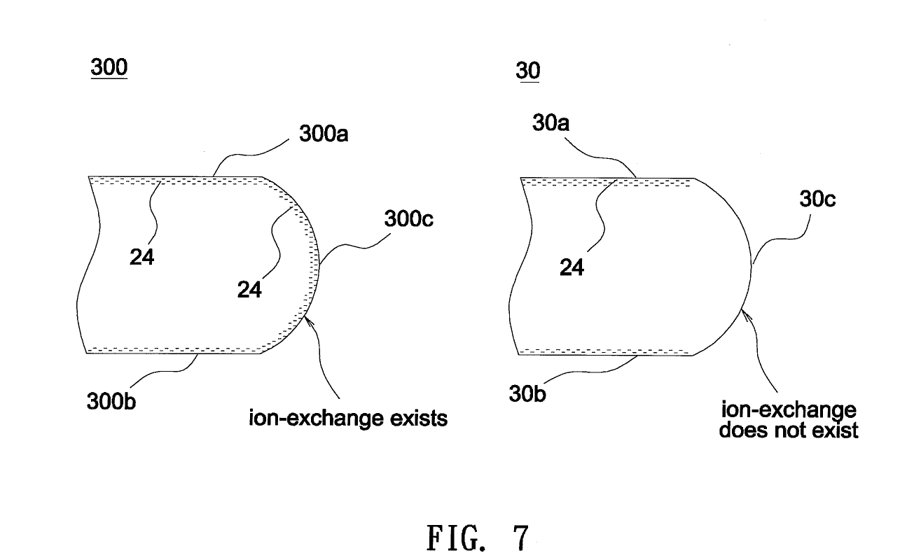

FIG. 7 shows a schematic diagram illustrating the comparison between a glass block cut from a tempered mother glass substrate according to another embodiment of the invention and a glass block according to a conventional design. As shown in the left side of FIG. 7, each conventional glass block 300 is cut from a non-tempered mother glass substrate, undergoes post treatment like edging or chamfering, and then given an ion-exchange strengthening treatment. Therefore, an ion-exchange layer 24 is formed on a top surface 300a, a bottom surface 300b, and a cut surface 300c. In comparison, according to this embodiment, a mother glass substrate is given an ion-exchange strengthening treatment first, and then each glass block 30 is cut from the tempered mother glass substrate and undergoes post treatment like edging or chamfering. As shown in the right side of FIG. 7, since each glass block 30 undergoes post treatment like edging or chamfering, the shielding layer 14 is removed from each glass block 30. Also, the ion-exchange layer 24 does not exist on the cut surface 30c of the tempered glass block 30. That is, interchanged ions are substantially not found on the cut surface 30c of the tempered glass block 30 (except an extremely small area of the cut surface 30c adjoining the top surface 30a and the bottom surface 30b), and the ion-exchange layer 24 are formed only on the top surface 30a and the bottom surface 30b of the glass block 30 to provide strengthening effects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims.

What is claimed is:

1. A method for cutting a tempered glass, comprising the steps of:
forming a shielding layer on a part of a surface of a glass substrate, wherein a predetermined cutting path passes through the part of the surface;
giving an ion-exchange strengthening treatment to the glass substrate, wherein the part of the surface covered by the shielding layer substantially does not undergo ion-exchange; and
cutting the glass substrate along the predetermined cutting path.

2. The method for cutting a tempered glass as claimed in claim 1, wherein the shielding layer comprises an inorganic material.

3. The method for cutting a tempered glass as claimed in claim 2, wherein the inorganic material is aluminum oxide, silicide, nitride, metal oxide, or metal.

4. The method for cutting a tempered glass as claimed in claim 1, further comprising the step of:
performing a mother glass fabrication process on the glass substrate given the ion-exchange strengthening treatment before cutting the glass substrate.

5. The method for cutting a tempered glass as claimed in claim 4, wherein the step of forming the shielding layer comprises:
coating an inorganic film on at least an entire surface of the glass substrate;
defining the predetermined cutting path on the inorganic film; and
removing the part of the inorganic film outside the predetermined cutting path.

6. The method for cutting a tempered glass as claimed in claim 4, wherein the mother glass fabrication process comprises a photolithography process or a screen printing process.

7. The method for cutting a tempered glass as claimed in claim 4, wherein the mother glass fabrication process comprises:
forming metal traces by a first photolithography process;
forming an insulation layer by a second photolithography process;
forming transparent X-axis traces and transparent Y-axis traces by a third photolithography process; and
forming a decorative layer by a screen printing process.

8. The method for cutting a tempered glass as claimed in claim 4, wherein the tempered glass is a transparent substrate of a display panel, or the tempered glass is a substrate or a cover lens of a touch panel.

9. The method for cutting a tempered glass as claimed in claim 4, further comprising the steps of:
giving edge enhancement or appearance modification to a periphery of the glass substrate.

10. The method for cutting a tempered glass as claimed in claim 9, further comprising:
etching the periphery of the glass substrate by an etching media.

11. A preparatory structure used in cutting a tempered glass, comprising:
a glass substrate given an ion-exchange strengthening treatment; and
at least one shielding layer formed on a part of a surface of the glass substrate and substantially overlapping a predetermined cutting path, wherein the part of the surface covered by the shielding layer substantially does not undergo ion-exchange.

12. A glass block cut from a tempered glass substrate, the tempered glass substrate being given an ion-exchange strengthening treatment, and the glass block comprising:
a top surface and a bottom surface opposite to each other;
a cut surface connected between the top surface and the bottom surface; and
an ion-exchange layer formed on the top surface and the bottom surface but substantially not formed on the cut surface.

13. The glass block cut from a tempered glass substrate as claimed in claim 12, further comprising:
a shielding layer formed on the top surface and the bottom surface at a position near the cut surface.

14. The glass block cut from a tempered glass substrate as claimed in claim 12, further comprising:
a shielding layer formed on the top surface and the bottom surface at a position overlapping a predetermined cutting path of the tempered glass substrate.

15. The glass block cut from a tempered glass substrate as claimed in claim 12, further comprising:
a decorative layer formed on at least one of the top surface and the bottom surface.

16. The glass block cut from a tempered glass substrate as claimed in claim 15, wherein the material of the decorative layer comprises at least one of diamond-like carbon, ceramic, colored ink, resin and photo resist.
